(19) United States
(12) Patent Application Publication
(10) Pub. No.: US 2009/0068519 A1
(43) Pub. Date: Mar. 12, 2009

(54) FUEL CELL AND METHOD OF MANUFACTURING THE SAME

(75) Inventor: Yuusuke Sato, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/206,939

(22) Filed: Sep. 9, 2008

(30) Foreign Application Priority Data
Sep. 11, 2007 (JP) 2007-235744

(51) Int. Cl. H01M 8/02; H01M 8/00

(52) U.S. Cl. 429/26; 429/27; 29/623.1

(57) ABSTRACT

A fuel cell having power-generating cells. The power-generating cells face each other, each having an anode-path plate provided on that surface that faces away from a proton conducting membrane. Heat-radiating fins are provided on the power-generating cells, respectively. Each heat-radiating fin has an exposed portion that contacts the anode-path plate of the associated power-generating cell and extends from the associated power-generating cell. The fuel cell can therefore keep generating electric power in a good condition.

### CROSS-REFERENCE TO RELATED APPLICATIONS

This application is based upon and claims the benefit of priority from the prior Japanese Patent Application No. 2007-235744 filed on Sep. 11, 2007 the entire contents of which are incorporated herein by reference.

### BACKGROUND OF THE INVENTION

1. Field of the Invention

The present invention relates to a fuel cell.

2. Description of the Related Art

A fuel cell is composed of a fuel electrode (anode electrode), an electrolyte membrane (proton conducting membrane), and an air electrode (cathode electrode). The anode electrode and the cathode electrode sandwich the electrolyte membrane. Hydrogen and oxygen are supplied to the fuel electrode and the air electrode, respectively, causing an electrochemical reaction. Changes in the free energy of the electrochemical reaction are directly extracted as electrical energy.

Of the various fuel cells available, the polymer electrolyte fuel cell (PEFC), which has a solid polymer membrane used as electrolyte membrane (proton conducting membrane), is now studied for practical use as a small household power supply, a portable power supply or a power supply for mobile devices. This is because the PEFC can generate a large output at low temperatures. The direct methanol fuel cell (DMFC) attracts attention as a power supply for electronic equipment such as portable computers, because it can provide a large output without being charged. With the DMFC it is easy to handle the fuel than with fuel cell units that use hydrogen as fuel. In addition, the DMFC system can be configured simply as a whole. This is why the DMFC is studied for a wide use as power supply not only in portable computers, but also in other various electronic equipments.

The conventional DMFC comprise a DMFC stack. The DMFC stack is composed of DMFC cells, each having, in most cases, a fuel electrode, an air electrode and an electrolyte membrane. Through a fuel-supplying path, a methanol aqueous solution is supplied to the fuel electrodes provided in the DMFC stack. Through an air-supplying path, air is supplied to the air electrodes provided in the DMFC stack. The air-supplying path has an inlet port. Through the inlet port, air is drawn from the atmosphere into the DMFC stack, which generates electric power.

In the DMFC stack so configured as described above, methanol reacts with H2O at each fuel electrode (anode electrode). Thus, the methanol is oxidized, generating carbon dioxide and hydrogen ions (protons) and electrons. In each DMFC cell, the hydrogen ions pass through the electrolyte membrane, reaching the air electrode. At the air electrode, the oxygen in the air combines with the hydrogen ions and the electrons, generating H2O. At this point, electrons move in the external circuit connected between the fuel-electrode unit and air-electrode unit of the DMFC stack. Hence, the DMFC generates electric power.

As described above, a fuel cell can provide a large electric power if composed of a plurality of power-generating cells (e.g., DMFCs) coupled together. An membrane electrode assembly (MEA) composed of a solid polymer electrolyte membrane and the anode electrode and cathode electrode that sandwich the electrolyte membrane, respectively, is interposed by separators thus forming a power-generating cell. In a direct methanol fuel cell (DMFC), for example, the anode-path plates and the cathode-path plates are alternately arranged, and membrane electrode assembly (MEA) are arranged, each interposed between an anode-path plate and a cathode-path plate adjacent to the anode-path plate. A DMFC stack is thereby formed.

More specifically, a fuel cell is a multi-layer sheet that comprises a first conductive membrane supplied with hydrogen gas and constituting a fuel-electrode electrode, an electrolyte membrane capable of conducting protons, and a second conductive membrane supplied with air and forming an air-electrode electrode, the electrolyte membrane being interposed between the first conductive membrane and the second conductive membrane. (See, for example, JP-A 2005-251740 (Kokai).)

Any fuel cell generates electric power through a chemical reaction between hydrogen and oxygen. Its power-generating section generates heat, because of the energy loss made during the chemical reaction and the electrical resistance of the material forming this section. Inevitably, the temperature of the power-generating section will increase.

The temperature increasing of the power-generating section impairs the stable operation of the fuel cell. In a polymer electrolyte fuel cell that has a power-generating unit comprising a solid polymer electrolyte membrane and electrodes sandwiching the electrolyte membrane, the H2O in the solid polymer electrolyte membrane gradually decreases in amount as the temperature of the power-generating unit increases. An undesirable phenomenon called dry-up will probably develop. A technique of radiating heat outside the power-generating section is therefore important, in view of the necessity of maintaining the H2O content in the range of an appropriate value in the solid polymer electrolyte membrane in order to achieve a stable electric power generation.

Since the solid polymer electrolyte membrane of the polymer electrolyte fuel cell contains H2O, the polymer electrolyte fuel cell must be cooled to 100° C. or less. In order to cool the polymer electrolyte fuel cell, an electrically conductive cooling plate having a coolant passage is used in all or some of the fuel cells constituting a fuel-cell stack. Further, for this purpose, the coolant passages of the cooling plates extend in the direction in which the fuel cells are laid one on another and are connected to the coolant inlet-outlet ports of separators, which communicate with the coolant passages of the cooling plates. The coolant, such as H2O, is made to flow through the coolant passages of the polymer electrolyte fuel cell, cooling the fuel-cell stack. (See, for example, JP-A 10-162842 (Kokai).)

As already pointed out, a fuel cell can provide a large electric power if composed of a plurality of power-generating cells (e.g., DMFCs) coupled together. Therefore, in a DMFC, for example, the anode-path plates and the cathode-path plates are alternately arranged, and membrane-electrode assemblies (MEAs) are arranged, each interposed between an anode-path plate and a cathode-path plate adjacent to the anode-path plate. A stack is thereby formed. Since the stack is composed of sealing members, heat-radiating fins, etc., as well as MEAs and path plates, the power-generating cells, if being planer ones, must be connected, one by one, in series. Consequently, the fuel cell is too large, or the power-generating cells must be well positioned with respect to one another. This will increase the number of steps of manufacturing the fuel cell, lower the efficiency of manufacturing the fuel cell and raise the cost of manufacturing the fuel cell.

The fuel cell disclosed in JP-A 2005-251740 (Kokai) comprises a folded sheet that forms a cell section consisting of pleat-like members. Therefore, the fuel cell can be manufactured by forming fewer steps, but no measures are taken to prevent a temperature increasing of the power-generating section. Specific measures must therefore be devised so that the heat generated in the power-generating section may be radiated from power-generating section.

### SUMMARY OF THE INVENTION

It is an object of the present invention to provide a fuel cell which can be manufactured in few steps, in which heat can be radiated from the power-generating section, and which can keep generating electric power in a good condition.

In a aspect of the present invention, there is provided a fuel cell which includes: membrane-electrode assemblies, each having a proton conducting membranes, an anode electrode formed on one surface of the proton conducting membrane, and a cathode electrode formed on the other surface of the proton conducting membrane; and

power-generating cells, each having an anode-path plate provided on that surface of the anode electrode, which faces away from the proton conducting membrane,

wherein heat-radiating fins are provided on the power-generating cells, respectively, and extend from the membrane-electrode assemblies.

### BRIEF DESCRIPTION OF THE DRAWINGS

FIG. 1A is a plan view of a membrane-electrode assembly of the first pattern, for use in a fuel cell according to an embodiment of the present invention;

FIG. 1B is a sectional side view of the membrane-electrode assembly shown in FIG. 1A;

FIG. 2A is a plan view of a membrane-electrode assembly of the second pattern, for use in a fuel cell according to another embodiment of the present invention;

FIG. 2B is a sectional side view of the membrane-electrode assembly shown in FIG. 2A;

FIG. 3 is a sectional side view of a first embodiment of a fuel cell according to the present invention;

FIG. 4 is a diagram explaining the sequence of assembling the first embodiment of the fuel cell;

FIG. 5 is a sectional side view of a second embodiment of the fuel cell;

FIG. 6 is a diagram explaining the sequence of assembling the second embodiment of the fuel cell;

FIG. 7A is a plan view of a membrane-electrode assembly of the second pattern, for use in a third embodiment of the fuel cell;

FIG. 7B is a sectional side view of the membrane-electrode assembly shown in FIG. 7A;

FIG. 8 is a sectional side view of the third embodiment of the fuel cell;

FIG. 9 is a diagram explaining the sequence of assembling the third embodiment of the fuel cell;

FIG. 10 is a sectional side view of a fourth embodiment of the fuel cell;

FIGS. 11A to 11C are diagrams illustrating the components of each power-generating cell incorporated in the fourth embodiment of the fuel cell;

FIG. 12A is a side view explaining the sequence of assembling the fourth embodiment of the fuel cell;

FIG. 12B is a plan view of the fourth embodiment;

FIG. 13A is a side view explaining a different sequence of assembling the fourth embodiment of the fuel cell; and

FIG. 13B is a plan view of the fourth embodiment so assembled as explained with reference to FIG. 13A.

### DETAILED DESCRIPTION OF THE INVENTION

Embodiments of the present invention will be described with reference to the accompanying drawings. In the drawings, the components of each embodiment, which are identical to those of any other embodiment, are designated by the same reference numbers. Once described, such components will not be described again.

The membrane-electrode assemblies (MEAs), which are stuck one on another in each embodiment, are identical in basic structure to those of any other embodiment, though the electrodes are arranged in a different pattern. The basic structure of the membrane-electrode assemblies will be described below, for all embodiments.

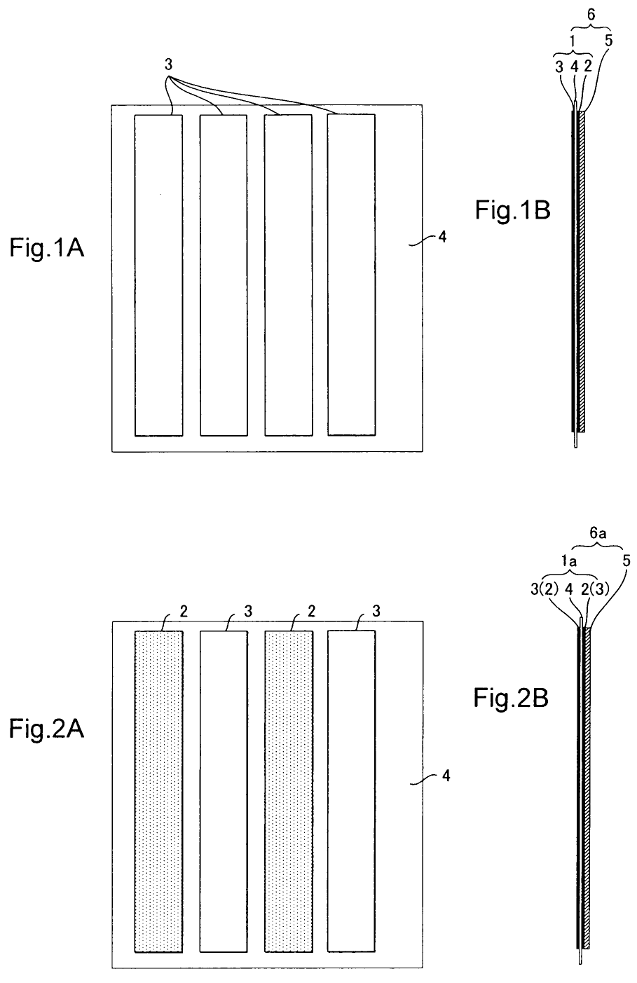

FIG. 1A is a plan view of a membrane-electrode assembly of the first pattern, for use in a fuel cell according to the present invention. FIG. 1B is a sectional side view of the membrane-electrode assembly. The membrane-electrode assembly (MEA) 1 of the first pattern comprises anode electrodes 2, cathode electrodes 3, and a proton conducting membrane 4. The anode electrodes 2 are formed on one surface of the proton conducting membrane 4, and the cathode electrodes 3 are formed on the other surface of the proton conducting membrane 4.

As shown in FIGS. 1A and 1B, the anode electrodes 2, which are fuel electrodes to receive H2O and proton-generating fuel, and the cathode electrodes 3, which are air electrodes to receive oxidant gas or oxygen, are shaped like a plate. The anode electrodes 2 are opposed to the cathode electrodes 3, respectively, across the proton conducting membrane 4. An anode-path plate 5 is provided, contacting that surface of the anode electrode 2, which faces away from the proton conducting membrane 4. The membrane-electrode assembly 1 and the anode-path plate 5 constitute a power-generating cell 6.

Each anode electrode 2 is a multi-layer member, constituted by a catalyst layer (not shown) and a diffusion layer (not shown). The catalyst layer guides gas for promoting the reaction between H2O and proton-generating fuel, to the surface of the proton conducting membrane 4. The diffusion layer diffuses H2O and proton-generating fuel over the surface of the catalyst layer, thus bringing the H2O and the fuel into contact with the catalyst layer.

The catalyst layer contains catalyst, polytetrafluoroethylene (PTFE) powder and proton conductive resin. The catalyst comprises, for example, carbon particles and fine platinum-alloy or ruthenium-alloy particles held on the carbon particles. The PTFE powder imparts H2O-repellent property to the catalyst layer, ultimately accomplishing smooth diffusion of gas. The proton conductive resin forms ion-conducting paths in the catalyst layer. The diffusion layer is made of, for example, porous carbon material such as porous sintered carbon.

The proton-generating fuel supplied to the anode electrodes 2 is organic fuel that releases electrons and protons upon reacting with H2O in the presence of catalyst. The proton-generating fuel is usually an alcohol such as methanol or ethanol.

In the present embodiment, the proton-generating fuel is mixed with H2O, forming an aqueous solution, which is supplied to the anode electrodes 2.

Each cathode electrode 3 has a catalyst layer (not shown) and a diffusion layer (not shown) and is a multi-layered structure. The catalyst layer is provided on that surface that faces the proton conducting membrane 4 and promotes the reaction between oxygen and protons. The diffusion layer diffuses oxygen over the surface of the catalyst layer, bringing the oxygen into contact with the catalyst layer.

The catalyst layer contains catalyst, polytetrafluoroethylene (PTFE) powder, and proton conductive resin. The catalyst carries, for example, platinum fine powder. The PTFE powder imparts H2O-repelling property to the catalyst layer, ultimately achieving smooth diffusion of gas. The proton conductive resin forms ion-conducting paths in the catalyst layer. The diffusion layer is made of, for example, porous carbon material such as porous sintered carbon.

Air introduced from outside can be used as oxidant gas.

The proton conducting membrane 4 is a solid polymer electrolyte membrane shaped like a thin film. The membrane 4 is made of proton-conducting material such as perfluorosulfonic acid based polymer in which suspended side chains have a sulfonic-acid group at the distal end of Teflon (registered trademark) skeleton. The solid polymer electrolyte membrane can be, for example, a Flemion (trade name, manufactured by Asahi Glass Co., Ltd.) membrane, Nafion (trade name, manufactured by DuPont) membrane, or the like. The proton conducting membrane 4 constituted by such a solid polymer electrolyte membrane has strength, extensibility, elasticity, hardness and rigidity, all desirable for use in fuel cells.

The anode-path plate 5 is made of dense carbon. Although its internal structure is not shown in the drawings, the anode-path plate 5 has an inlet passage, parallel passages, and an outlet passage, which extend in the direction the fuel (methanol solution) flows. The fuel (methanol solution) first flows into the inlet passage, then flows through the parallel passages branched from the inlet passage, and is finally discharged though the outlet passage. Methanol and H2O are therefore supplied to the catalyst layer of the anode electrodes 2 of the membrane-electrode assembly 1. At the same time, air is supplied to the catalyst layer of the cathode electrode 3 of the membrane-electrode assembly 1. The catalyst layer of the anode electrode 2 and the catalyst layer of the cathode electrode 3 are covered with seal members (not shown).

A membrane-electrode assembly 1a of the second pattern, for use in the fuel cell will be described. The components of the membrane-electrode assembly 1a of the second pattern are similar to those of the membrane-electrode assembly 1 of the first pattern. Further, the anode-path plate 5 that constitutes a power-generating cell 6a, jointly with the membrane-electrode assembly 1a, is identical to the anode-path plate 5 of the membrane-electrode assembly 1. Therefore, the components of the membrane-electrode assembly 1a will not be described. Nor will the anode-path plate 5 of the cell 6a be described.

FIG. 2A is a plan view of a membrane-electrode assembly of the second pattern, for use in a fuel cell according to the present invention. FIG. 2B is a sectional side view of the membrane-electrode assembly. As FIG. 2A shows, anode electrodes 2 and cathode electrodes 3 are alternately arranged on either surface of a proton conducting membrane 4. Note that the anode electrodes 2 and cathode electrodes 3 are alternately arranged in an order on one surface of the membrane 4, and in a different order on the other surface of the membrane 4. Each anode electrode 2 may therefore oppose a cathode electrode 3 across the proton conducting membrane 4.

Some embodiments of fuel cells, each comprising a power-generating cell 6 having a membrane-electrode assembly 1 or a power-generating cell 6a having a membrane-electrode assembly 1a, will be described.

### First Embodiment

First embodiment uses membrane-electrode assemblies 1 of the first pattern, which is of the type shown in FIG. 1.

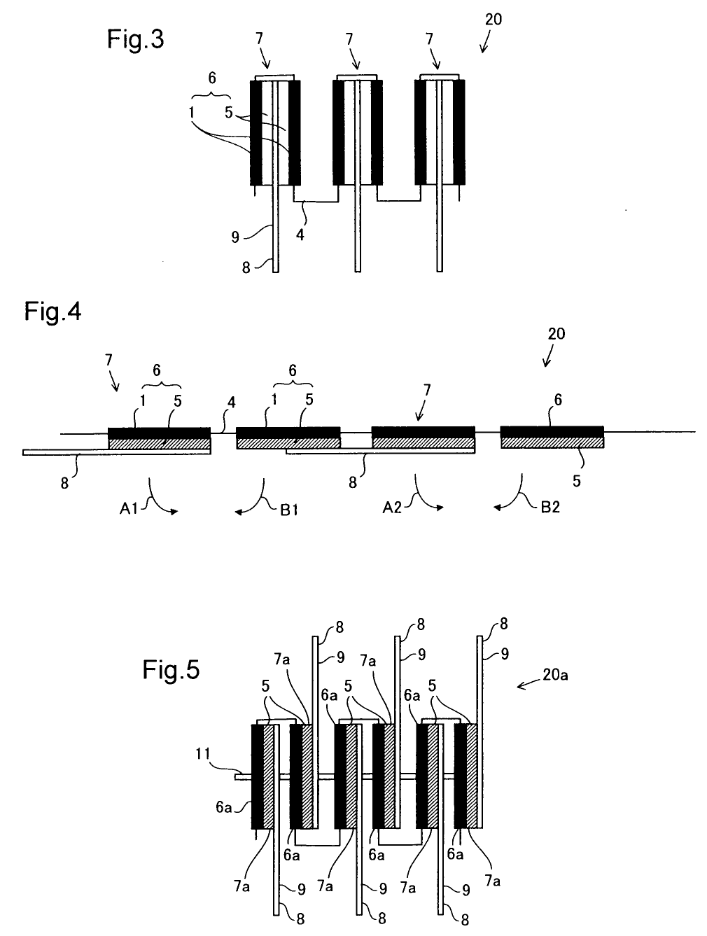

FIG. 3 is a sectional side view of the first embodiment, i.e., a fuel cell 20 according to the present invention. As FIG. 3 shows, power-generating cell assemblies 7 are arranged at regular intervals and laid one on another. Each power-generating cell assembly 7 comprises two power-generating cells 6 and a heat-radiating fin 8 made of Ni. Each power-generating cell 6 is composed of a membrane-electrode assembly 1 and an anode-path plate 5. The heat-radiating fin 8 is interposed between the anode-path plates 5 of the two power-generating cell electrode assemblies 7. In other words, two anode-path plates 5 contact the heat-radiating fin 8 and are opposed to each other across the heat-radiating fin 8. The heat-radiating fin 8 has a larger area than the membrane-electrode assemblies 1 and extends longer than the power-generating cell 6. Therefore, the heat-radiating fin 8 extends longer than the power-generating cell 6, extends outside the one side of the fuel cell 20 and has an exposed portion 9. Cooling air coming from a cooling fan (not shown) is applied to the exposed portions 9 of the fins 8. The heat-radiating fins 8 are therefore cooled. Heat is thereby radiated from the heat-radiating fins 8.

FIG. 4 is a diagram explaining the sequence of assembling the fuel cell 20, i.e., first embodiment. As shown in FIG. 4, power-generating cells 6 are arranged in a row. Heat-radiating fins 8 are arranged, each on the anode-path plate 5 of every other power-generating cell 6. As described above, the heat-radiating fins 8 have a larger area than the power-generating cell 6. Thus, the exposed portion 9 of any fin 8 that is secured to a power-generating cell 6 contacts, in part, the anode-path plate 5 of the adjacent power-generating cell 6 to which a heat-radiating fins 8 is not secured, but the contact part is not secured to the cell 6. Therefore, it can move with respect to the anode-path plate 5.

First, as shown in FIG. 4, the power-generating cell assemblies 7, to which a heat-radiating fin 8 is secured, are folded in the directions of arrows A1 and A2. On the other hand, the power-generating cells 6, to which no heat-radiating fins 8 are secured, are folded in the directions of arrows B1 and B2. As a result, power-generating cell assemblies 7 are provided, each composed of a heat-radiating fin 8 and two power-generating cells 6 arranged on the sides of the fin 8, respectively. Thus, the fuel cell 20 shown in FIG. 3 is manufactured.

The fuel cell 20 according to the first embodiment can be manufactured in fewer steps than hitherto possible, and the heat generated in the power-generating section can be radiated outside. The fuel cell 20 can therefore generate electric power in good condition.

### Second Embodiment

Second embodiment uses membrane-electrode assemblies la of the second pattern shown in FIG. 2.

FIG. 5 is a sectional side view of the second embodiment, i.e., a fuel cell 20a according to the present invention. Power-generating cell assemblies 7a are laid one on another and arranged at regular intervals. Each power-generating cell assembly 7a comprises an anode-path plate 5, a power-generating cell 6a, and a heat-radiating fin 8 made of Ni. The anode-path plate 5 connects the power-generating cell 6a to the heat-radiating fin 8. The heat-radiating fin 8 has a larger area than the power-generating cell 6a, extends longer than the power-generating cell 6a, and has an exposed portion 9. The exposed portion 9 lies outside the fuel cell 20. The exposed portions 9 of the heat-radiating fins 8 extend alternately upwards and downwards as shown in FIG. 5. Cooling air coming from a cooling fan (not shown) is applied to the exposed portions 9 of the fins 8. The heat-radiating fins 8 are therefore cooled. Heat is thereby is radiated from the heat-radiating fins 8. A cathode-current collecting structure 11 is secured to the cathode electrodes 3 of each power-generating cell 6a. The anode electrodes 2 and cathode electrodes 3 are thereby arranged in series in each power-generating cell 6a.

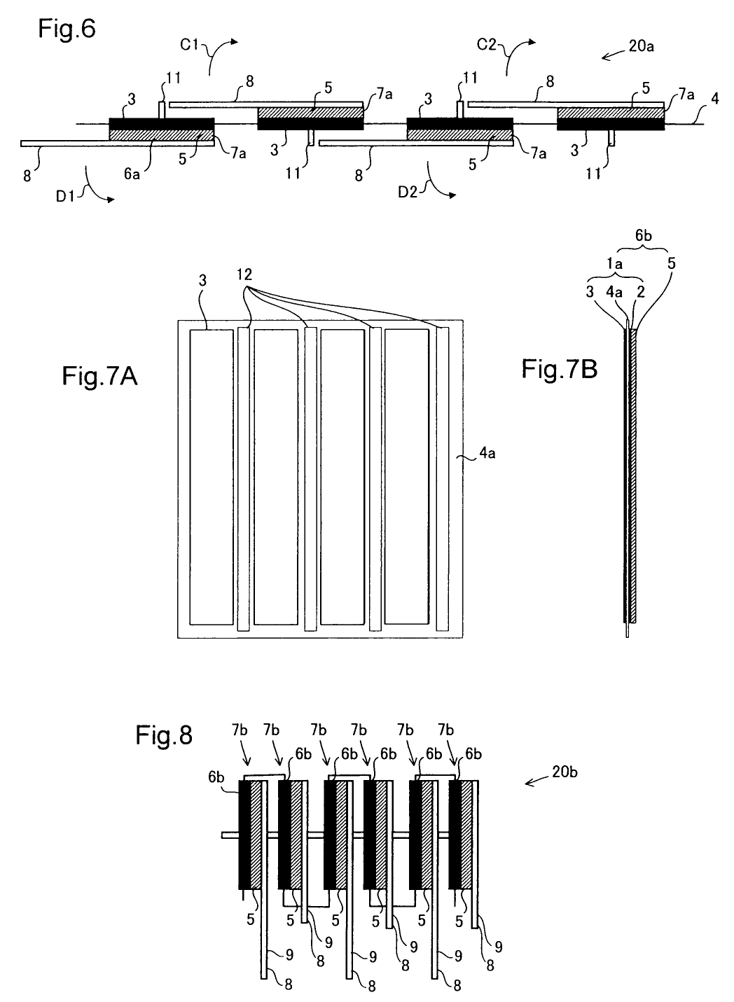

FIG. 6 is a diagram explaining the sequence of assembling second embodiment, i.e., fuel cell 20a according to the present invention. As FIG. 6 shows, power-generating cell assemblies 7a are arranged in a row, such that the anode electrodes 2 and the cathode electrodes 3 extend alternately in the opposite directions. Therefore, the anode-path plates 5 extend alternately in the opposite directions, too. Heat-radiating fins 8 are secured to the anode-path plates 5, respectively. Hence, in one power-generating cell assembly 7a, a heat-radiating fin 8 is provided on one surface of the proton conducting membrane 4, whereas in the adjacent power-generating cell assembly 7a, a heat-radiating fin 8 is provided on the other surface of the proton conducting membrane 4.

To assemble the fuel cell 20a, the heat-radiating fin 8 of any upper power-generating cell assembly 7a is bent upwards by 90° as indicated by arrows C1 and C2, and the heat-radiating fin 8 of any lower power-generating cell assembly 7a is bent downwards by 90° as indicated by arrows D1 and D2, as is illustrated in FIG. 6. A fuel cell 20a of the second embodiment is thereby provided, in which the exposed portions 9 of the heat-radiating fins 8 on each power-generating cell assembly 7a extend alternately upwards and downwards in FIG. 6.

Therefore, the fuel cell 20a according to the second embodiment can be manufactured in fewer steps than hitherto possible, and the heat generated at each power-generating cell 6a can be radiated outside. The fuel cell 20a can therefore generate electric power in good condition.

### Third Embodiment

A fuel cell 20b, i.e., third embodiment of the present invention, is identical in basic structure to the fuel cell 2a, i.e., second embodiment of the present invention. The fuel cell 20b differs from the fuel cell 2a in two respects. First, all heat-radiating fins 8 are secured, extending from only one side of the fuel cell 20b. Second, each membrane-electrode assembly 1a has indeed the second pattern, but the proton conducting membrane 4a of the membrane-electrode assembly 1a has fin-guiding holes 12 which through the heat-radiating fins 8 path.

FIG. 8 is a sectional side view of the fuel cell 20b, i.e., third embodiment. Power-generating cell assemblies 7b are arranged at regular intervals and laid one on another. As FIG. 8 shows, each power-generating cell assembly 7b comprises an anode-path plate 5, a power-generating cell 6b, extends outside the power-generating cell 6b and a heat-radiating fin 8 made of Ni. The anode-path plate 5 connects the power-generating cell 6b to the heat-radiating fin 8. The heat-radiating fin 8 has a larger area than the power-generating cell 6b, extends longer than the power-generating cell 6b, and has an exposed portion 9. The exposed portions 9 of any two adjacent fins 8 have different areas, but both lie at one side of the fuel cell 20b. Cooling air coming from a cooling fan (not shown) is applied to the exposed portions 9 of the fins 8. The heat-radiating fins 8 are therefore cooled. Heat is thereby radiated from the heat-radiating fins 8. A cathode-current collecting structure 11 is secured to the cathode electrodes 3 of each power-generating cell 6b. The anode electrodes 2 and cathode electrodes 3 are thereby arranged in series in each power-generating cell 6b.

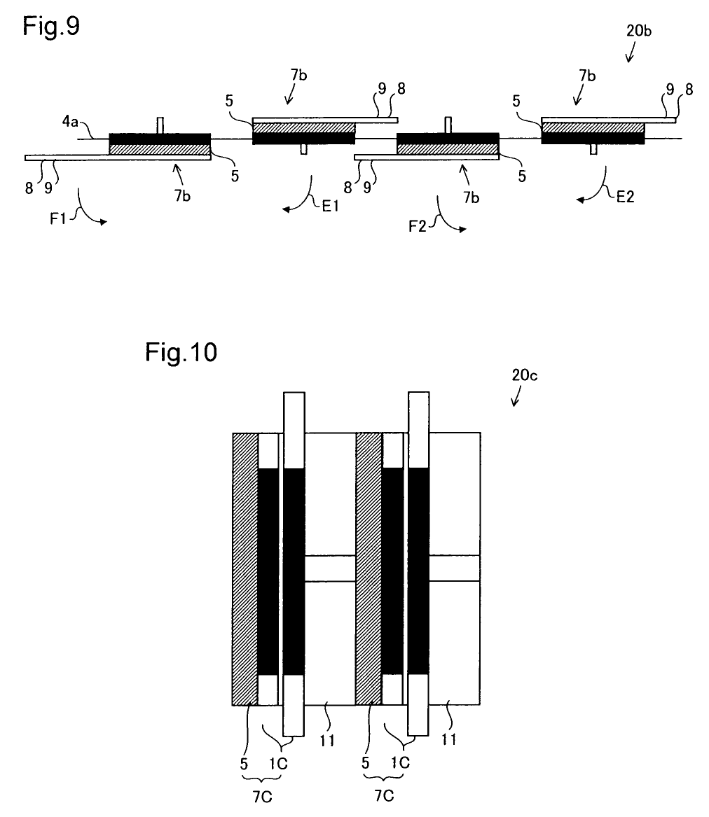

FIG. 9 is a diagram explaining the sequence of assembling the fuel cell 20b, i.e., third embodiment of the present invention. As seen from FIG. 9, power-generating cell assemblies 7b are arranged in a row, such that the anode electrodes 2 and the cathode electrodes 3 extend alternately in the opposite directions. Therefore, the anode-path plates 5 extend alternately in the opposite directions, too. Heat-radiating fins 8 are secured to the anode-path plates 5, respectively. Hence, in one power-generating cell assembly 7b, a heat-radiating fin 8 is provided on one surface of the proton conducting membrane 4a, whereas in the adjacent power-generating cell assembly 7b, a heat-radiating fin 8 is provided on the other surface of the proton conducting membrane 4a. Note that the exposed part 9 of the fin 8 provided on one surface of the proton conducting membrane 4a is smaller than the exposed part 9 of the fin 8 that is provided on the other surface of the proton conducting membrane 4a. Further, between the electrodes formed on the proton conducting membrane 4a, fin-guiding holes 12 are provided, through which the heat-radiating fins 8 pass.

To assemble the fuel cell 20b, the heat-radiating fin 8 of any upper power-generating cell assembly 7b is first passed through a fin-guiding hole 12 the proton conducting membrane 4 and then bent downwards by 90° as indicated by arrows E1 and E2 as shown in FIG. 9. Further, the heat-radiating fin 8 of any lower power-generating cell assembly 7b is bent downwards by 90° as indicated by arrows F1 and F2, as shown in FIG. 9, too. A fuel cell 20b of the third embodiment is thereby provided, in which the exposed portion 9 of each heat-radiating fin 8 lies on one side of each power-generating cell assembly 7b, as is shown in FIG. 8.

Therefore, the fuel cell 20b according to the third embodiment can be manufactured in fewer steps than hitherto possible, and the heat generated at each power-generating cell 6a can be radiated outside. The fuel cell 20a can therefore generate electric power in good condition.

### Fourth Embodiment

In a fourth embodiment, a seal member covers the anode electrodes 2 and cathode electrodes 3 of each power-generating cell 6c. Moreover, each heat-radiating fin 8 serves as seal member. Further, a cathode-current collecting structure 11 not only spaces a power-generating cell assemblies 7a, one from another, but also holds the assemblies 7a together.

The membrane-electrode assemblies 1c of the fourth embodiment are a modification of the membrane-electrode assemblies 1a of the second pattern shown in FIG. 2.

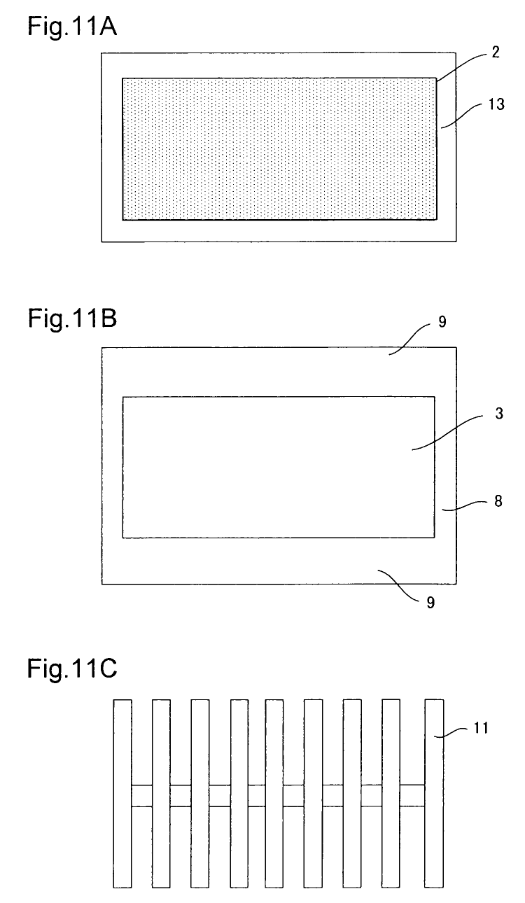

FIG. 10 is a sectional side view of the fourth embodiment, i.e., a fuel cell 20c according to the present invention. As shown in FIG. 10, power-generating cell assemblies 7c are spaced apart at regular intervals by the cathode-current collecting structure 11. As shown in FIG. 11A, each anode electrode 2 is covered with a seal member 13. As shown in FIG. 11B, each cathode electrode 3 is covered with a frame-shaped seal member. A part of the frame-shaped seal member severs as a heat-radiating fin 8. The heat-radiating fin 8 extends outside a fuel cell 20c and has an exposed portion 9. As shown in FIG. 11C, the cathode-current collecting structures 11 are comb-teeth structures and functions as not only spacer but also as holder.

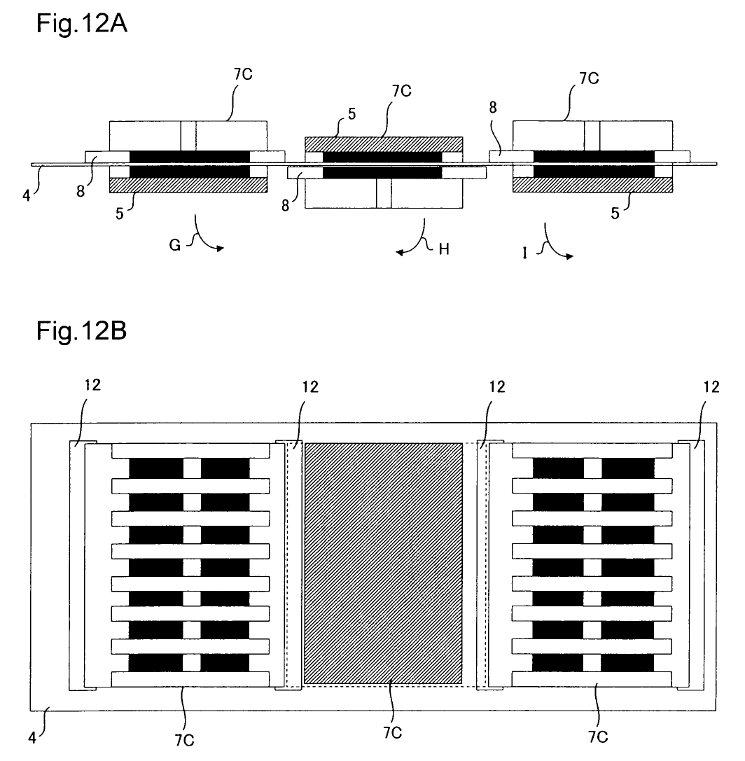

FIGS. 12A and 12B are diagrams explaining the sequence of assembling the fourth embodiment, i.e., a fuel cell 20c according to the present invention. As FIG. 12A is a sectional side view of the fuel cell 20c. FIG. 12B is a plan view of the fuel cell 20c.

As FIGS. 12A and 12B show, power-generating cell assemblies 7c are arranged in a row, such that the anode electrodes 2 and the cathode electrodes 3 extend alternately in the opposite directions. Therefore, the anode-path plates 5 extend alternately in the opposite directions, too. Hence, in one power-generating cell assembly 7c, a heat-radiating fin 8 is provided on one surface of the proton conducting membrane 4, whereas in the adjacent power-generating cell assembly 7c, a heat-radiating fin 8 is provided on the other surface of the proton conducting membrane 4. Further, between the electrodes (anode electrodes 2 and cathode electrodes 3) formed on the proton conducting membrane 4, fin-guiding holes 12 are provided, through which the heat-radiating fins 8 pass.

To assemble the fuel cell 20c, the heat-radiating fins 8 of any three adjacent power-generating cell assemblies 7d are first passed through fin-guiding holes 12 and then bent in the directions G, H and I, respectively, such that the cathode-current collecting structures 11 face the anode-path plates 5, respectively. Therefore, a fuel cell 20c of the fourth embodiment can be provided, in which the exposed portions 9 of the heat-radiating fins 8 of any two adjacent power-generating cells 6c extend upwards and downwards, respectively, as shown in FIG. 10.

In the fourth embodiment, the seal member for each heat-radiating fin 8 is provided on the cathode electrode 3. Instead, the seal member may be provided on the anode electrode 2, or on both the anode electrode 2 and the cathode electrode 3.

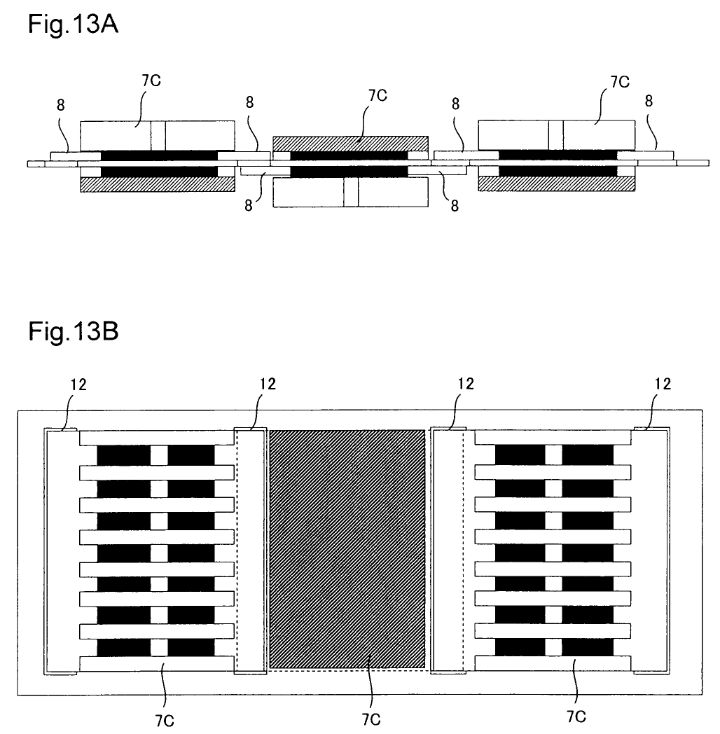

As seen from FIGS. 12A and 12B, the upper and lower heat-radiating fins 8 have such sizes that they would not interfere with each other when they are bent. Nonetheless, the upper and lower heat-radiating fins 8 may have such sizes as shown in FIG. 13A (sectional side view) and FIG. 13B (plan view). Even if they interfere with each other when bent, they will undergo elastic deformation, and no particular problems will arise.

Therefore, the fuel cell 20c according to the fourth embodiment can be manufactured in fewer steps than hitherto possible, and the heat generated at each power-generating section can be radiated outside. The fuel cell 20c can therefore generate electric power in good condition.

The present invention is not limited to the embodiments described above. The components of any embodiment can be modified in various manners in reducing the invention to practice, without departing from the spirit or scope of the invention. Further, the components of any embodiment described above may be combined, if necessary, in various ways to make different inventions. For example, some of the component of any embodiment may not be used. Moreover, the components of the different embodiments may be combined in any desired fashion.

What is claimed is:

1. A fuel cell comprising:
membrane-electrode assemblies, each having a proton conducting membranes, an anode electrode formed on one surface of the proton conducting membrane, and a cathode electrode formed on the other surface of the proton conducting membrane;
power-generating cells, each having an anode-path plate provided on that surface of the anode electrode, which faces away from the proton conducting membrane, and
heat-radiating fins provided on the power-generating cells, respectively, and extend from an outer portion of the membrane-electrode assemblies.

2. The fuel cell according to claim 1, wherein
the heat-radiating fins contact the anode-path plates of the power-generating cells.

3. The fuel cell according to claim 1, wherein
the heat-radiating fins extend in the same direction with respect to the power-generating cells.

4. The fuel cell according to claim 2, wherein
the heat-radiating fins extend in the same direction with respect to the power-generating cells.

5. The fuel cell according to claim 3, wherein
the heat-radiating fins extend for different distances, in the respective power-generating cells.

6. The fuel cell according to claim 4, wherein
the heat-radiating fins extend for different distances, in the respective power-generating cells.

7. The fuel cell according to claim 1, wherein
the heat-radiating fins extend in different directions, in accordance with on which power-generating cell each is provided.

8. The fuel cell according to claim 1, wherein
the cathode electrode or anode electrode, or both, of each membrane-electrode assembly are sealed with heat-radiating fins that serve as seal members, too.

9. The fuel cell according to claim 1, wherein
cathode-current collecting structures are provided between the power-generating cells.

10. The fuel cell according to claim 9, wherein
the cathode-current collecting structures are comb-teeth structures.

11. A method of manufacturing a fuel cell, comprising:
forming a plurality of anode electrodes on one surface of a proton conducting membrane and a plurality of cathode electrodes on the other surface of the proton conducting membrane;
providing anode-path plates on the anode electrodes, respectively, thereby forming a plurality of power-generating cells;
providing heat-radiating fins on the power-generating cells, respectively; and
bending the proton conducting membrane at parts where the power-generating cells are spaced apart from one another, thereby stacking the power-generating cells, one on another.
